(19) United States
(12) Patent Application Publication
(10) Pub. No.: US 2019/0050820 A1
(43) Pub. Date: Feb. 14, 2019

(54) SERVICE MANAGEMENT SYSTEM, SERVER APPARATUS, AND VEHICLE

(71) Applicant: TOYOTA JIDOSHA KABUSHIKI KAISHA, Toyota-shi (JP)

(72) Inventor: Ryuta ATSUMI, Toyota-shi (JP)

(73) Assignee: TOYOTA JIDOSHA KABUSHIKI KAISHA, Toyota-shi (JP)

(21) Appl. No.: 16/026,549

(22) Filed: Jul. 3, 2018

(30) Foreign Application Priority Data
Aug. 9, 2017 (JP) 2017-154576

(51) Int. Cl. G06Q 10/10

(52) U.S. Cl. CPC G06Q 10/1095

(57) ABSTRACT

A service management system includes a schedule storage unit configured to store identification information, in which a user of a vehicle, a service category to be provided or received by the user, and an execution authority of an operation of the vehicle assigned to the user are associated with one another, and schedule information, in which the identification information and a time of day are associated with each other as one service, and an operation permission and prohibition determination unit configured to determine whether the operation of the vehicle is to be executed based on the schedule information.

### INCORPORATION BY REFERENCE

The disclosure of Japanese Patent Application No. 2017-154576 filed on Aug. 9, 2017 including the specification, drawings and abstract is incorporated herein by reference in its entirety.

### BACKGROUND

### 1. Technical Field

The present disclosure relates to a service management system that performs management of an execution schedule of a service in a vehicle or the like, a server apparatus, and a vehicle.

### 2. Description of Related Art

A technique in which a plurality of electronic keys is assigned to a vehicle has been suggested. Japanese Unexamined Patent Application Publication No. 2014-227741 (JP 2014-227741 A) discloses an electronic key system that allows a high-function mobile phone or the like to be registered as a new electronic key. A new service, such as car sharing where an owner of a vehicle rents the vehicle to other people, delivery to a trunk of a vehicle by a delivery agent, or traveling refueling by a fuel supply vehicle, has been suggested.

### SUMMARY

In a case where one vehicle is made to be used by a plurality of users, such as an owner of a vehicle, an operator, and a user of car sharing, in order to prevent duplication of a use time of day of the vehicle and to maintain security, there is a need to set an operation authority of each unit of the vehicle according to each user in more detail. The setting described above is difficult, in particular, in a case where there is a plurality of operators.

The disclosure provides a service management system, a server apparatus, and a vehicle capable of easily managing a use time of day or an operation authority in a case where a plurality of users uses a vehicle.

A first aspect of the disclosure relates to a service management system including a schedule storage unit and an operation permission and prohibition determination unit. The schedule storage unit is configured to store identification information (ID information), in which a user of a vehicle, a service category to be provided or received by the user, and an execution authority of an operation of the vehicle assigned to the user are associated with one another, and schedule information, in which the ID information and a time of day are associated with each other as one service. The operation permission and prohibition determination unit is configured to determine whether or not the operation of the vehicle is to be executed based on the schedule information.

According to the first aspect of the disclosure, a schedule is managed in a unified manner, and thus, even though there is a plurality of users, it is possible to suitably manage a use time of day or an operation authority and to appropriately control whether or not a vehicle is to be used based on the management.

The service management system according to the first aspect of the disclosure may further include a service end determination unit configured to determine whether or not each service associated with a time of day until the present ends. The operation permission and prohibition determination unit may be is configured to, in a case where the service end determination unit determines that there is an unended service in the time of day until the present, further determine whether or not to limit or delay assignment of an operation authority of the vehicle based on the unended service and the ID information associated with a current time of day compared to a case where there is no unended service.

According to the first aspect of the disclosure, even though an unexpected delay or the like occurs, a flexible action becomes possible in a subsequent service.

The service management system according to the first aspect of the disclosure may further include a profit management unit configured to manage profit or cost occurring on the user. In a case where the operation permission and prohibition determination unit determines to restrict the operation of the vehicle, the profit management unit may increase profit or reduce cost on a user indicated by the ID information associated with the current time of day compared to a case where the operation of the vehicle is not restricted.

According to the first aspect of the disclosure, in a case where an unexpected change occurs in a service content, it is possible to perform appropriate compensation.

The service management system according to the first aspect of the disclosure may further include a service permission and prohibition determination unit configured to, based on the ID information associated with a previous time of day, specify the ID information associatable with a future time of day not associated with the ID information based on the schedule information, and a notification unit configured to provide notification of the future time of day and the ID information specified by the service permission and prohibition determination unit.

According to the first aspect of the disclosure, it is possible to propose a service that is registerable in a free time, and convenience is improved.

In the service management system according to the first aspect of the disclosure, the schedule storage unit, the service end determination unit, the profit management unit, and the service permission and prohibition determination unit may be included in a server apparatus, and the operation permission and prohibition determination unit may be included in the vehicle.

In the service management system according to the first aspect of the disclosure, the service category may include a category indicating car sharing and a category indicating delivery to the vehicle.

According to the first aspect of the disclosure, it is possible to apply the disclosure to a car sharing service and a delivery service.

A second aspect of the disclosure relates to a server apparatus including a schedule storage unit. The schedule storage unit is configured to store ID information, in which a user of a vehicle, a service category to be provided or received by the user, and an execution authority of an operation of the vehicle assigned to the user are associated with one another, and schedule information, in which the ID information and a time of day are associated with each other as one service.

According to the second aspect of the disclosure, a schedule is managed in a unified manner, and thus, even though there is a plurality of users, it is possible to suitably manage a use time of day or an operation authority.

A third aspect of the disclosure relates to a vehicle including an operation permission and prohibition determination unit. The operation permission and prohibition determination unit is configured to acquire ID information, in which a user of the vehicle, a service category to be provided or received by the user, and an execution authority of an operation of the vehicle assigned to the user are associated with one another, and schedule information, in which the ID information and a time of day are associated with each other as one service, and determine whether or not the operation of the vehicle is to be executed based on the ID information and the schedule information.

According to the third aspect of the disclosure, it is possible to appropriately control whether or not a vehicle is to be used based on schedule information.

A fourth aspect of the disclosure relates to a service management system including a schedule registration unit and a schedule restriction unit. The schedule registration unit is configured to receive a registration request of at least a delivery schedule where a delivery agent delivers a cargo to a vehicle, a takeout schedule where an owner of the vehicle takes out the delivered cargo, and a sharing schedule where the vehicle is provided to a car sharing service, and register the at least the delivery schedule, the takeout schedule and the sharing schedule. The schedule restriction unit is configured not to permit the registration of the sharing schedule between the delivery schedule and the takeout schedule.

In the service management system according to the fourth aspect of the disclosure, in a case where the delivery schedule, the takeout schedule, and the sharing schedule are registered in the schedule registration unit in this execution order, the schedule restriction unit may confirm execution of the delivery schedule and the takeout schedule, and while the delivery schedule ends and the takeout schedule does not end, change a content of the sharing schedule.

According to the fourth aspect of the disclosure, it is possible to suitably achieve both of receiving a delivery service to a vehicle and providing a car sharing service to the same vehicle.

According to the aspects of the disclosure, it is possible to provide a service management system, a server apparatus, and a vehicle capable of managing a schedule in a unified manner, and thus, even though there is a plurality of users, suitably managing a use time of day or an operation authority and appropriately controlling whether or not a vehicle is to be used based on the management.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a schedule according to an embodiment of the disclosure;

FIG. 2 is a table showing an example of a restriction content for each type of key according to the embodiment of the disclosure;

FIG. 3 is a table showing an example of schedule information according to the embodiment of the disclosure;

FIG. 4A is a diagram showing processing of a service management system according to the embodiment of the disclosure;

FIG. 4B is a diagram showing processing of the service management system according to the embodiment of the disclosure;

FIG. 4C is a diagram showing processing of the service management system according to the embodiment of the disclosure;

FIG. 5A is a diagram showing processing of the service management system according to the embodiment of the disclosure;

FIG. 5B is a diagram showing processing of the service management system according to the embodiment of the disclosure;

FIG. 5C is a diagram showing processing of the service management system according to the embodiment of the disclosure;

FIG. 5D is a diagram showing processing of the service management system according to the embodiment of the disclosure;

FIG. 6 is a functional block diagram of the service management system according to the embodiment of the disclosure;

FIG. 7 is a processing sequence diagram of the service management system according to the embodiment of the disclosure; and

FIG. 8 is a processing sequence diagram of the service management system according to the embodiment of the disclosure.

### DETAILED DESCRIPTION OF EMBODIMENTS

Outline

In a service management system according to the aspect of the disclosure, a server apparatus manages a schedule when a plurality of users uses a vehicle, and a vehicle operates within an authority range based on a vehicle operation authority to a user according to the schedule.

### Embodiment

Hereinafter, an embodiment of the disclosure will be described in detail referring to the drawings.

Schedule

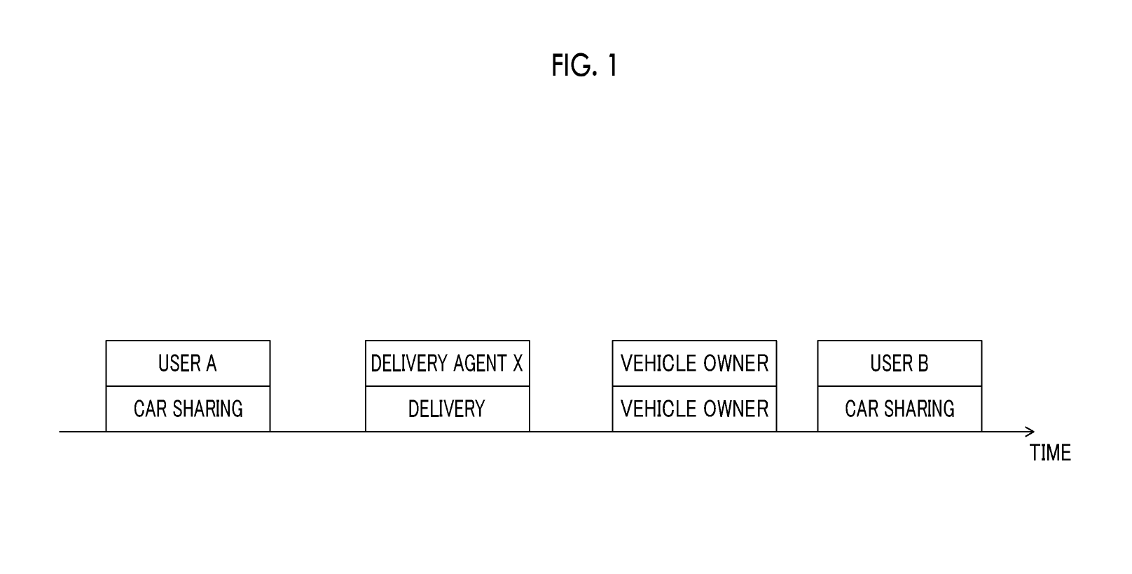

FIG. 1 shows an example of a schedule in the embodiment. In the example shown in FIG. 1, four services are reserved for a specific vehicle. In the embodiment, it is assumed that a service means that a user uses a vehicle in a specific time of day to acquire convenience or that a user uses a vehicle to provide convenience for an owner of the vehicle, and also includes that the owner of the vehicle uses the vehicle. First, a user A as a user uses a vehicle in order to receive a car sharing service. Next, a delivery agent X as a user uses a trunk of the vehicle in order to provide a delivery service of storing a cargo addressed to the owner of the vehicle in the trunk of the vehicle. Next, the owner of the vehicle as a user uses the vehicle. Next, a user B as a user uses the vehicle in order to receive a car sharing service.

Key

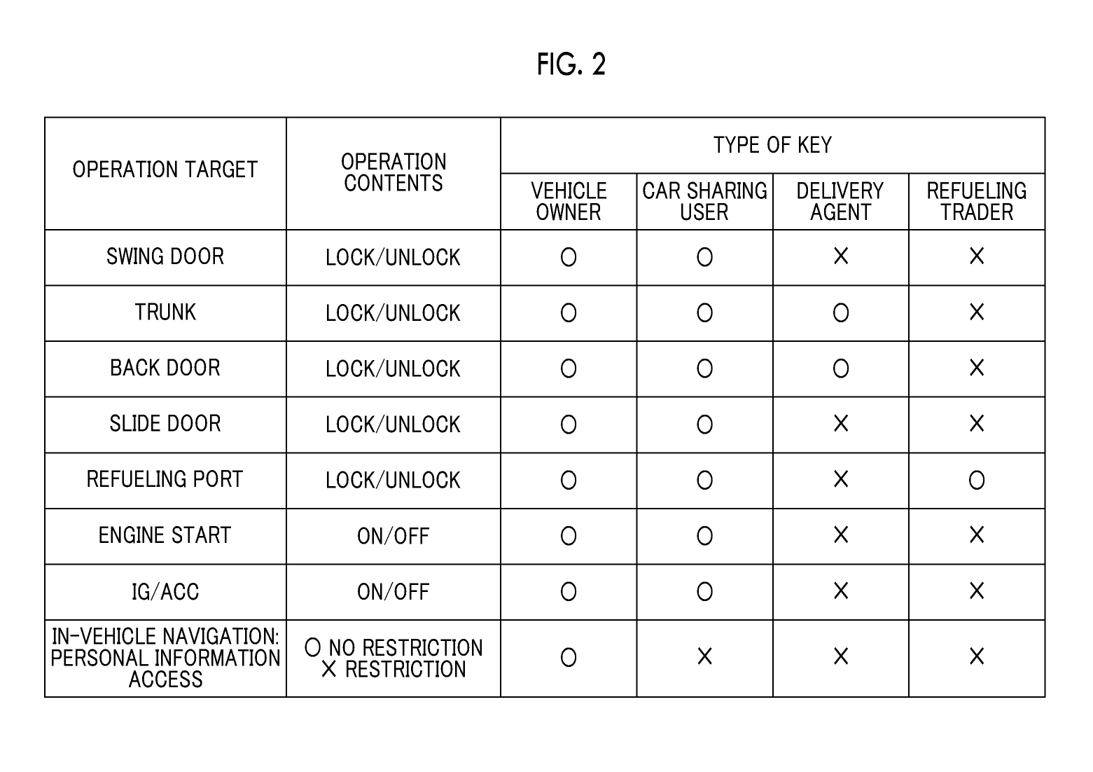

The user of the vehicle can use a portable terminal device, such as a smartphone carried with the user, as a key for a vehicle according to a predetermined procedure. The vehicle performs authentication processing through short-range wireless communication with the key, and in a case where authentication is successful, permits the user to perform an operation of the vehicle within a restriction range according to the type of key. FIG. 2 shows an example of a restriction content for each type of key according to a user. A key of an owner of a vehicle is made to perform all operations. A user of a car sharing service may get in a vehicle and performs driving or may load and carry a cargo into a vehicle; thus, the user of the car sharing service can perform all operations other than access to personal information of the owner of the vehicle or the like stored in an in-vehicle navigation device. A delivery agent does not need to drive a vehicle and may store a delivered cargo in a trunk or the like; thus, the delivery agent can perform solely unlocking and locking operations for opening and closing the trunk or a back door. A refueling trader may refuel without needing to drive a vehicle; thus, the refueling trader can perform solely unlocking and locking operations of a refueling port.

Data

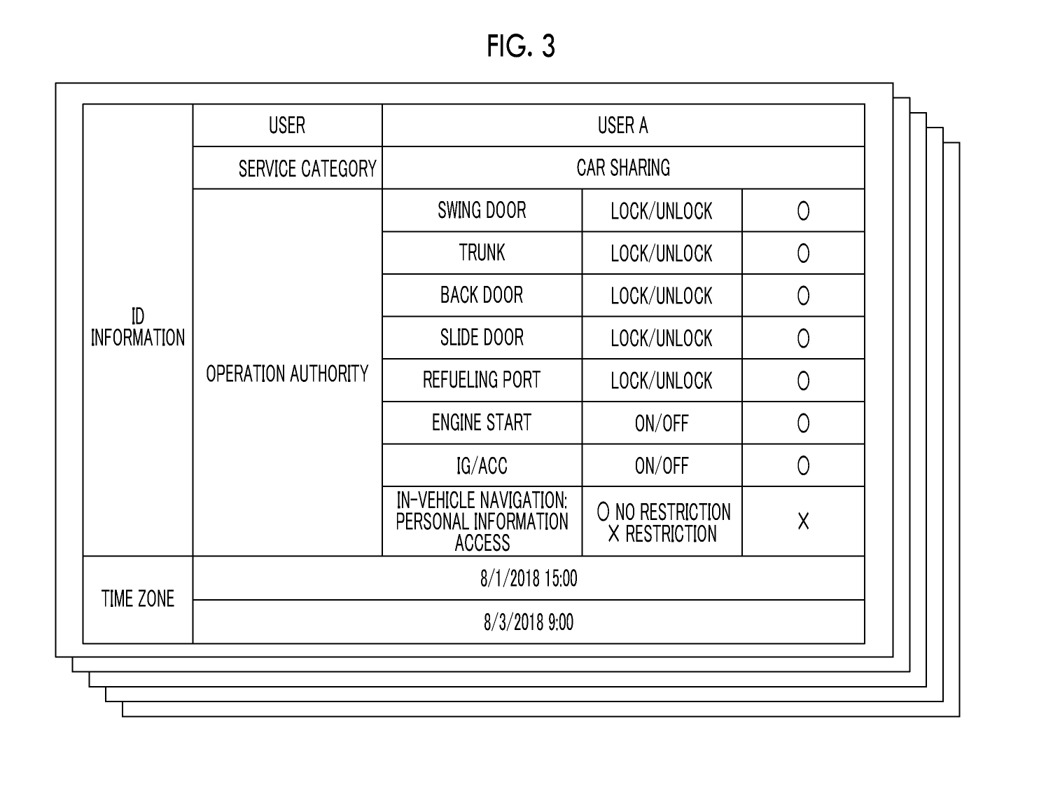

FIG. 3 shows an example of schedule information that is data indicating a schedule. The schedule information can include a plurality of pieces of data, in which ID information and a time of day are associated with each other. The ID information indicates a user registered as a person who can use a vehicle, a service to be provided or received by the user, and an operation authority of the vehicle of the user in the service. That is, a time of day where each service is executed is registered in the schedule information, and the schedule information indicates a time of day, a user, a service, and a vehicle operation in a case where the vehicle operation is permitted.

Characteristics of Service Management System

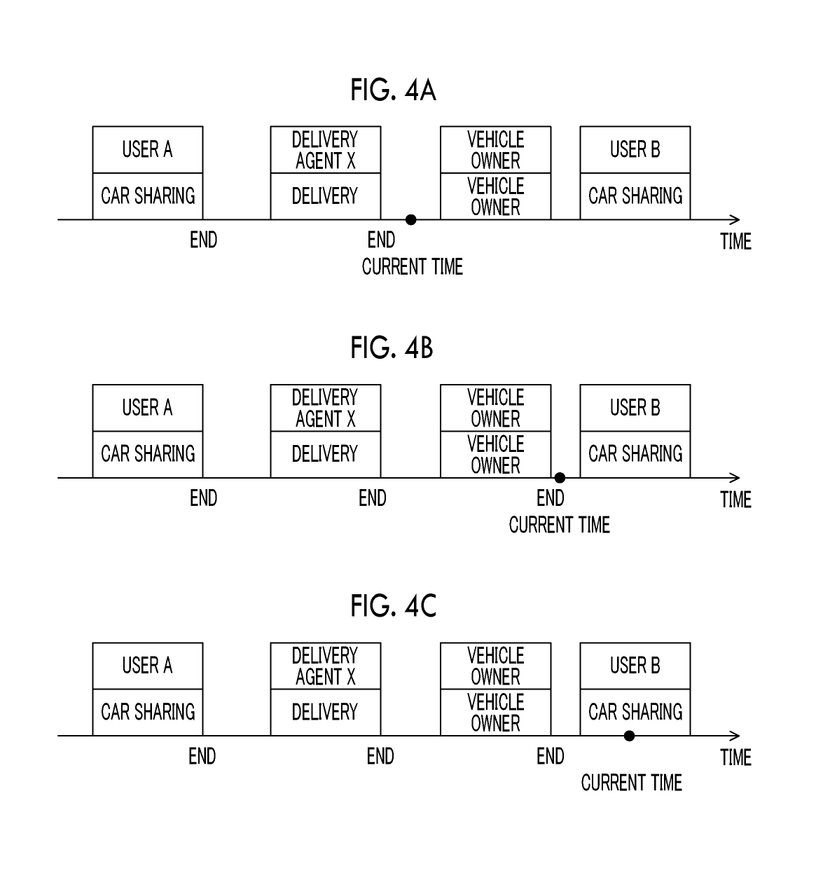

Characteristic processing of the service management system according to the embodiment will be described referring to FIGS. 4A to 4C. FIG. 4A shows that the delivery service by the delivery agent X ends at a current time. When the delivery service ends, a cargo is stored in a trunk of a vehicle and the trunk is locked. FIG. 4B shows that the use of the vehicle by the owner of the vehicle ends at a current time. When the use of the vehicle ends, the trunk is opened and the cargo is taken out by the owner of the vehicle. For this reason, since there is no problem even though the trunk is opened to the user B, thereafter, a car sharing service can be provided to the user B as in FIG. 4C.

Here, in a case where the use of the vehicle by the owner of the vehicle is not performed or the vehicle is unused against the schedule, when the cargo still remains in the trunk and another person can open the trunk, it is not desirable for safety. In the case described above, for example, a use period of the vehicle by the owner of the vehicle is extended, and the time when the car sharing service by the user B is startable is delayed or the service is cancelled. Alternatively, while the time when the car sharing service by the user B is startable is not delayed, the user B may be restricted to perform the unlocking operation of the trunk. As described above, in a case where a service does not end in a predetermined time of day due to circumstances, the next service is delayed or cancelled, or an unpermitted operation is added. In the case described above, a user of the next service can receive compensation such that cost is reduced or a profit is increased.

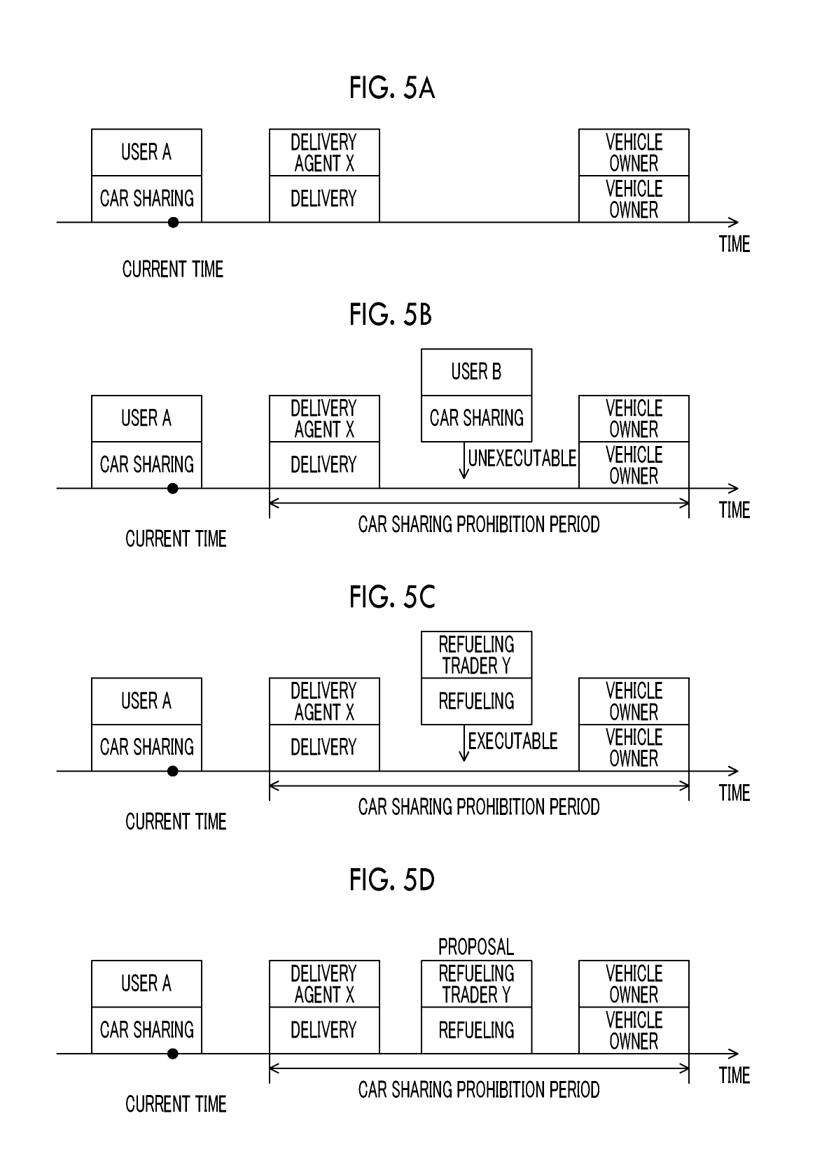

Another characteristic processing of the service management system according to the embodiment will be described referring to FIGS. 5A to 5D. FIG. 5A shows there is a free time between the delivery service by the delivery agent X and the use of the vehicle by the owner of the vehicle. However, as shown in FIG. 5B, since the car sharing service cannot be suitably executed for the free time due to the above-described reason, it is impossible to add the car sharing service. However, as shown in FIG. 5C, a refueling service by a refueling trader Y where solely opening and closing of the refueling port are permitted can be suitably executed. As described above, it is possible to specify a service executable or a service unexecutable for the free time based on the schedule information. In the embodiment, it is possible to propose a service executable for the free time to the owner of the vehicle or the like.

Configuration

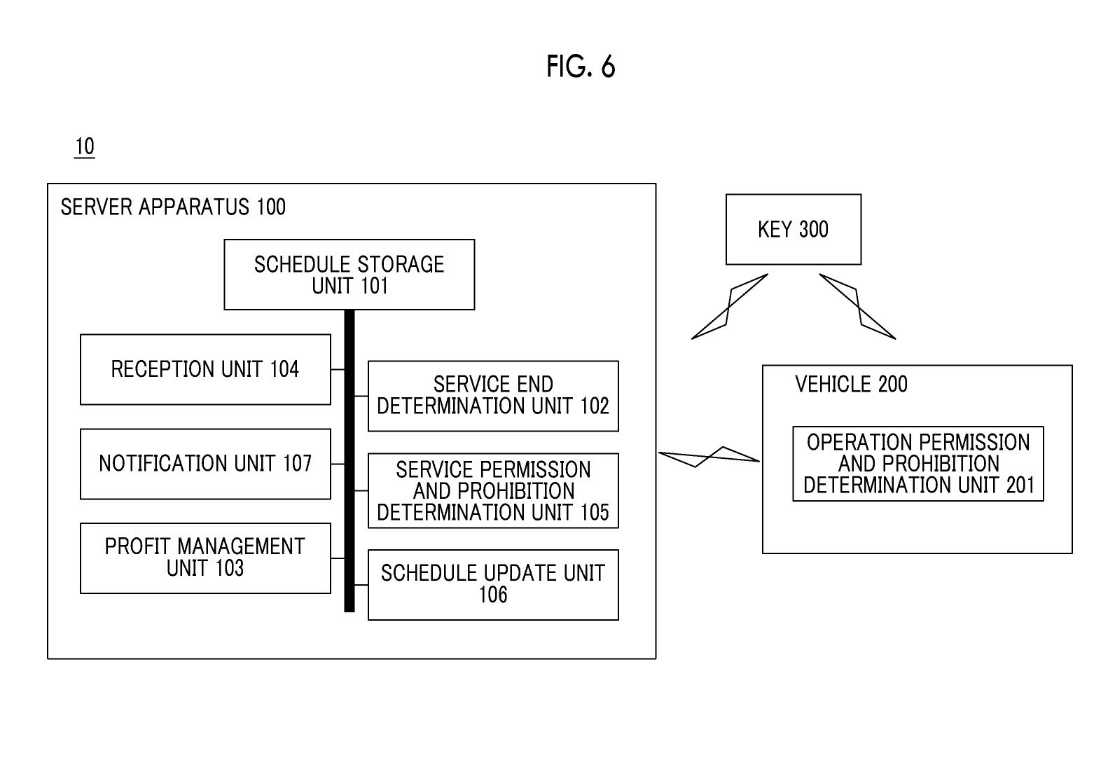

FIG. 6 is a functional block diagram of the service management system 10 according to the embodiment. The service management system 10 is included in a collaboration system including a server apparatus 100, a vehicle 200, and a key 300 as an example.

The server apparatus 100 includes a schedule storage unit 101 that stores the above-described schedule information, a service end determination unit 102 that determines whether or not a service ends in a past time of day, a profit management unit 103 that manages a profit to be obtained by the user, cost to be paid by the user, or the like regarding the service, a reception unit 104 that receives a request of new service registration from the owner of the vehicle or the like, a service permission and prohibition determination unit 105 that specifies a service executable for a free time, a notification unit 107 that notifies the owner of the vehicle or the like of the service specified by the service permission and prohibition determination unit 105, and a schedule update unit 106 that updates schedule information at the time of service addition or the like.

The key 300 is a portable terminal device having a short-range wireless communication function, such as a smartphone, as described above, and is carried with each user. The server apparatus 100 generates information for authentication for making the portable terminal device function as the key 300, for example, based on a request from an owner of the smartphone and a consent of the owner of the vehicle 200, and assigns an operation authority for the vehicle 200 based on the schedule information.

The vehicle 200 includes an operation permission and prohibition determination unit 201. The operation permission and prohibition determination unit 201 performs wireless communication with the server apparatus 100 to acquire schedule information or the like, and performs short-range wireless communication with the key 300 to authenticate the key 300 or to determine whether or not various operations to the vehicle 200 are to be permitted. In regard to an operation permitted by the operation permission and prohibition determination unit 201, the vehicle 200 unlocks a door, or the like when the user executes the operation.

Although each of the server apparatus 100, the operation permission and prohibition determination unit 201 of the vehicle 200, and the key 300 includes a communication unit (not shown) that performs wireless communication or a controller that controls the functions of the units, the communication unit or the controller may be provided in any unit or independently.

Service Execution

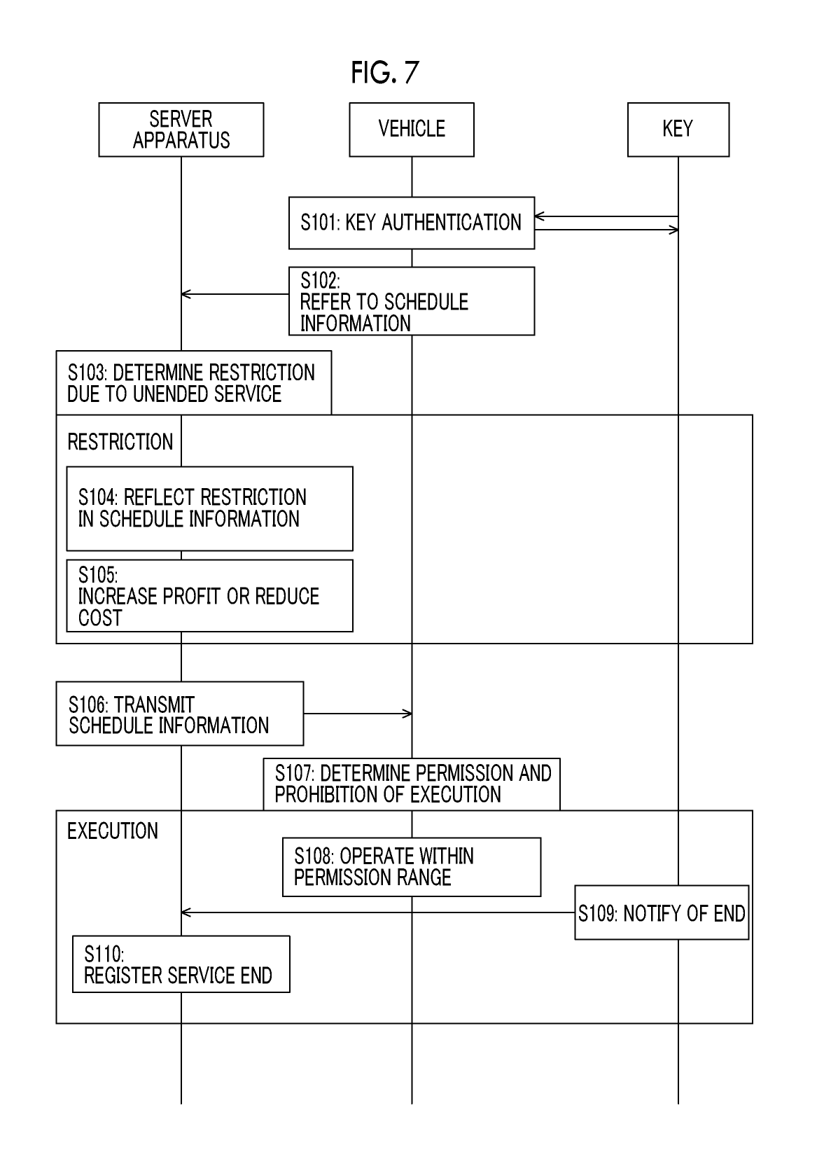

Processing that the service management system 10 performs will be described. FIG. 7 shows a processing sequence where a service is made executable in a case where the key 300 moves near the vehicle 200 and can perform short-range wireless communication.

Step S101: The operation permission and prohibition determination unit 201 of the vehicle 200 performs short-range wireless communication with the nearby key 300 to perform authentication of the key 300. For example, in a case where the key 300 is associated with a user registered in advance, authentication is successful. The operation permission and prohibition determination unit 201 may inquire an external device, such as the server apparatus 100, of information for authentication as needed, for example. In a case where authentication fails, the process ends.

Step S102: The operation permission and prohibition determination unit 201 of the vehicle 200 inquires the server apparatus 100 of the schedule information.

Step S103: The controller of the server apparatus 100 reads the schedule information stored in the schedule storage unit 101. In a case where there is an unended service until the present, the service end determination unit 102 specifies the unended service. For example, the controller of the server apparatus 100 compares a service category or an operation authority included in the ID information based on a service in a current time of day included in the schedule information and the unended service, thereby determining whether or not to restrict the current service. For the determination, for example, a predetermined rule that “in a case where the use of the owner of the vehicle is unended after the delivery service, the start of the car sharing service is delayed” may be prepared and used. As the content of the restriction, prohibition of opening and closing of the trunk with reduction in executable operations causing the delay of the start time, or service cancellation is exemplified. Determination about whether or not a service is unended can be made through processing of Steps S109 and S110 described below, for example.

Step S104: In a case where determination is made to restrict the service in Step S103, the controller of the server apparatus 100 reflects the restriction in the read schedule storage unit 101, updates the time of day or the operation authority, and progresses to Step S105.

Step S105: In a case where determination is made to restrict the service in Step S103, the controller of the server apparatus 100 increases or reduces the profit or cost managed by the profit management unit 103 by a predetermined amount for the user subjected to service restriction by a predetermined amount.

Step S106: In both of a case where determination is made to restrict the service in Step S103 and a case where determination is made not to restrict the service in Step S103, the controller of the server apparatus 100 transmits the schedule information to the operation permission and prohibition determination unit 201 of the vehicle 200. In a case where the current service is not included in the schedule information, the process ends.

Step S107: The operation permission and prohibition determination unit 201 of the vehicle 200 determines whether or not each operation of the vehicle is to be executed based on the schedule information. In a case where there is an executable operation, the process progresses to Step S108, and in a case where there is no executable operation, the process ends.

Step S108: The operation permission and prohibition determination unit 201 of the vehicle 200 operates the vehicle 200 within a range received from the user as a range in which execution is permitted.

Step S109: In a case where the use of the vehicle 200 ends, as an example, the user notifies, from the key, the server apparatus 100 that the use of the vehicle ends.

Step S110: The controller of the server apparatus 100 stores the end of the current service in the schedule storage unit 101, for example, in association with the schedule information based on the notification that the use ends. The processing of Steps S109 and S110 is illustrative, and for example, the notification that the use of the vehicle 200 ends may be performed when the vehicle 200 receives a predetermined operation. Alternatively, a global positioning system (GPS) function may be provided in the vehicle 200 and the key 300, and determination may be made by comparison of GPS information. In a case where determination cannot be made that the use ends even though the time of day is passed, a service execution time may be extended or a forced end may be performed based on the service category or notification may be given to the owner of the vehicle.

As described above, it is possible to control whether or not the vehicle is to be used for a plurality of users based on the schedule information through the processing. Even though an unexpected delay or the like occurs, a flexible action becomes possible in a subsequent service. In a case where an unexpected change occurs in the service content, it is possible to perform appropriate compensation. In the above-described example, although a case where the key 300 moves near the vehicle 200 and can perform short-range wireless communication is used as a trigger of the start of the processing, therebefore, internal data of the server apparatus 100 may be updated and prepared, for example, based on the schedule information when a scheduled time is reached.

Service Proposal and Registration

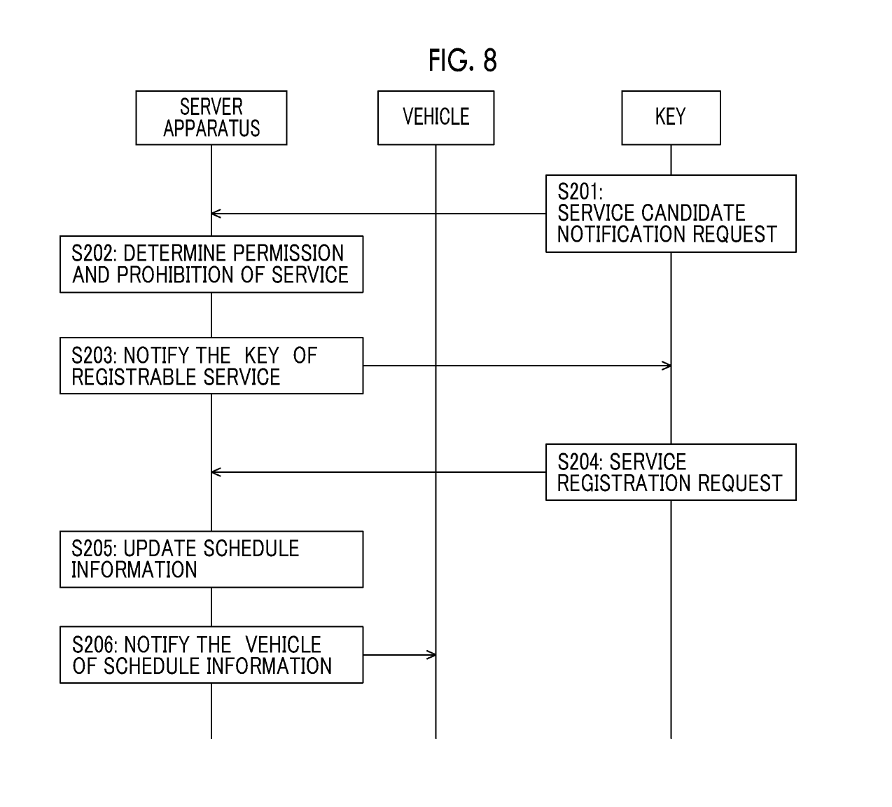

In the embodiment, it is possible to propose a candidate of a service newly registerable in a free time of a schedule to the owner of the vehicle. FIG. 8 shows a processing sequence where a service registerable in a free time is notified to the key 300 of the owner of the vehicle.

Step S201: The key 300 transmits a service candidate notification request to the server apparatus 100. The request is performed, for example, through an operation of the user. Alternatively, the request may be performed at a regular interval without depending on an operation of the user.

Step S202: The service permission and prohibition determination unit 105 of the server apparatus 100 reads the schedule information from the schedule storage unit 101 and specifies an ID associatable with a future time of day not associated with the ID information based on the service category, the operation authority, or the like included in the ID information of a service in a previous time of day. As needed for determination, as in Step S103 described above, a predetermined rule determined in advance may be used. As the future time of day, for example, a predetermined number of time of days may be selected in an order of time of days closer to the present. Alternatively, designation of a desired time of day may be received from the owner of the vehicle through the key 300.

Step S203: in Step S202, in a case where one or more pieces of associatable ID information can be specified, the notification unit 107 of the server apparatus 100 notifies the key 300 of the ID information and the time of day associatable with the ID information as a service candidate.

Step S204: When there is a service candidate that the owner of the vehicle desires additional registration in the schedule information from the notified service candidates, the owner of the vehicle selects the desired service candidate. The key 300 receives a selection operation and transmits a service registration request for registration of the selected service to the server apparatus 100.

Step S205: In a case where the reception unit 104 of the server apparatus 100 receives the service registration request, the schedule update unit 106 updates the schedule information and stores the schedule information in the schedule storage unit 101 based on the service registration request.

Step S206: The server apparatus 100 notifies the vehicle 200 of the schedule information.

With the above processing, the server apparatus 100 can propose a service registerable in a free time of day, thereby achieving improvement of convenience. In a case where a service for additional registration in a free time of day is already determined, it is possible to perform the service registration request while designating the service for additional registration. In this case, it is desirable to determine whether or not to perform service registration based on the service category, the operation authority, or the like included in the ID information of a service in a time of day before the free time of day. As described above, a predetermined rule determined in advance may be used. The service registration may be executed by the owner of the vehicle solely or may be executed by another user who received permission from the owner of the vehicle. The server apparatus 100 may notify a candidate of a registerable service, for example, at a regular interval even though there is no request from the key 300.

The above configuration or processing sequence is just an example, and the disclosure is not limited thereto. For example, the units constituting the server apparatus 100 may be distributed and disposed in a plurality of servers as long as the schedule information can be managed in a unified manner, or may be disposed in the vehicle 200 instead of the server apparatus. The data structure of the ID information, the schedule information, or the like and processing based on the data structure may be suitably modified, separated, and integrated. For example, priority may be given to a service category, and priority or the like of registration of a service may be set based on the priority of the service category.

In a case where a smartphone is used as the key 300, it is possible to transmit and receive various kinds of information between the server apparatus 100 and the key 300. The user may confirm information relating to a schedule through the key 300 at any time. The vehicle 200 may record an operation history or a driving history, and the owner of the vehicle may confirm the record of the operation history or the driving history through the server apparatus 100 and the key 300. With the above description, it is possible to detect a case where there is an unauthorized use of a vehicle. The owner of the vehicle may be assigned with a privileged authority to forcibly restrict an operation of the vehicle 200 to forcibly end an unauthorized use of the vehicle. Exchange of various kinds of information and instructions described above may be performed using not only the key 300 but also a device, such as another personal computer, as long as appropriate personal authentication can be performed.

As the service category, in addition to car sharing, the delivery agent, and the refueling trader, a cleaning company, a mechanic, or the like is exemplified. It is possible to take action on various services by assigning an appropriate operation authority. The server apparatus 100 performs a request to an operator and registration in the schedule information in a lump in cooperation with or in integration with a server of the operator.

The disclosure can be typically embodied as the following service management system. That is, the service management system includes a schedule registration unit configured to receive a registration request of at least a delivery schedule where a delivery agent delivers a cargo to a vehicle, a takeout schedule where an owner of the vehicle takes out the delivered cargo, and a sharing schedule where the vehicle is provided to a car sharing service, and register the at least the delivery schedule, the takeout schedule and the sharing schedule; and a schedule restriction unit configured not to permit registration of the sharing schedule between the delivery schedule and the takeout schedule.

In a case where the delivery schedule, the takeout schedule, and the sharing schedule are registered in the schedule registration unit in this execution order, the schedule restriction unit may confirm execution of the delivery schedule and the takeout schedule, and while the delivery schedule ends and the takeout schedule does not end, may change the content of the sharing schedule.

With the above description, it is possible to suitably achieve both of receiving a delivery service to a vehicle and providing a car sharing service to the same vehicle.

The disclosure can be regarded as not only a system including a server apparatus, a vehicle, and a key, but also a method that a plurality of computers including a processor executes. The disclosure can also be regarded as the server apparatus or the vehicle constituting the system.

Effects

According to the above embodiment, a schedule is managed in a unified manner, and thus, even though there is a plurality of users, it is possible to suitably manage a time of day or an operation authority and to appropriately control whether or not a vehicle is to be used based on the management. Even though a delay or the like occurs, it is possible to take appropriate action, such as authority restriction, delay, or compensation, in a subsequent service.

The disclosure is useful for a service using a vehicle, or the like.

What is claimed is:

1. A service management system comprising:
a schedule storage unit configured to store identification information, in which a user of a vehicle, a service category to be provided or received by the user, and an execution authority of an operation of the vehicle assigned to the user are associated with one another, and schedule information, in which the identification information and a time of day are associated with each other as one service; and
an operation permission and prohibition determination unit configured to determine whether the operation of the vehicle is to be executed based on the schedule information.

2. The service management system according to claim 1, further comprising a service end determination unit configured to determine whether each service associated with a time of day until present ends,
wherein the operation permission and prohibition determination unit is configured to, when the service end determination unit determines that there is an unended service in the time of day until the present, further determine whether or not to limit or delay assignment of an operation authority of the vehicle based on the unended service and the identification information associated with a current time of day compared to a case where there is no unended service.

3. The service management system according to claim 2, further comprising a profit management unit configured to manage profit or cost occurring on the user,
wherein, when the operation permission and prohibition determination unit determines to restrict the operation of the vehicle, the profit management unit increases profit or reduces cost on a user indicated by the identification information associated with the current time of day compared to a case where the operation of the vehicle is not restricted.

4. The service management system according to claim 3, further comprising:
a service permission and prohibition determination unit configured to, based on the identification information associated with a previous time of day, specify the identification information associatable with a future time of day not associated with the identification information based on the schedule information; and
a notification unit configured to provide notification of the future time of day and the identification information specified by the service permission and prohibition determination unit.

5. The service management system according to claim 4, wherein:
the schedule storage unit, the service end determination unit, the profit management unit, and the service permission and prohibition determination unit are included in a server apparatus; and
the operation permission and prohibition determination unit is included in the vehicle.

6. The service management system according to claim 1, wherein the service category includes a category indicating car sharing and a category indicating delivery to the vehicle.

7. A server apparatus comprising a schedule storage unit configured to store identification information, in which a user of a vehicle, a service category to be provided or received by the user, and an execution authority of an operation of the vehicle assigned to the user are associated with one another, and schedule information, in which the identification information and a time of day are associated with each other as one service.

8. A vehicle comprising an operation permission and prohibition determination unit configured to
acquire identification information, in which a user of the vehicle, a service category to be provided or received by the user, and an execution authority of an operation of the vehicle assigned to the user are associated with one another, and schedule information, in which the identification information and a time of day are associated with each other as one service, and
determine whether the operation of the vehicle is to be executed based on the identification information and the schedule information.

9. A service management system comprising:
a schedule registration unit configured to
receive a registration request of at least a delivery schedule where a delivery agent delivers a cargo to a vehicle, a takeout schedule where an owner of the vehicle takes out the delivered cargo, and a sharing schedule where the vehicle is provided to a car sharing service, and
register the at least the delivery schedule, the takeout schedule and the sharing schedule; and
a schedule restriction unit configured not to permit the registration of the sharing schedule between the delivery schedule and the takeout schedule.

10. The service management system according to claim 9, wherein, in a case where the delivery schedule, the takeout schedule, and the sharing schedule are registered in the schedule registration unit in this execution order, the schedule restriction unit confirms execution of the delivery schedule and the takeout schedule, and while the delivery schedule ends and the takeout schedule does not end, changes a content of the sharing schedule.
